(19) United States
(12) Patent Application Publication
(10) Pub. No.: US 2024/0048244 A1
(43) Pub. Date: Feb. 8, 2024

(54) DEVICE FOR GENERATING WIDE CAPTURE RANGE FREQUENCY TUNABLE OPTICAL MILLIMETER-WAVE SIGNAL

(71) Applicant: Zhejiang University, Hangzhou (CN)

(72) Inventors: Xiaofeng Jin, Hangzhou (CN); Ling Yang, Hangzhou (CN); Ping Wang, Hangzhou (CN); Jie Li, Hangzhou (CN); Yafeng Zhu, Hangzhou (CN); Xiangdong Jin, Hangzhou (CN); Yinfang Xie, Hangzhou (CN)

(21) Appl. No.: 17/818,305

(22) Filed: Aug. 8, 2022

(51) Int. Cl. H04B 10/50; H04B 10/58; H04B 10/63; H04B 10/294

(52) U.S. Cl. CPC H04B 10/50575; H04B 10/5051; H04B 10/58; H04B 10/63; H04B 10/2941

(57) ABSTRACT

A device for generating wide capture range frequency tunable optical millimeter-wave signal includes a millimeter-wave signal generating structure, a millimeter-wave signal modulation structure, an optical delay phase detection structure and a feedback control loop. The millimeter-wave signal generating structure obtains millimeter-wave signal by beat frequency of the optical signal generated by a master laser and a slave laser, the millimeter-wave signal is modulated onto an optical carrier of the master laser by the electro-optical modulation structure, and then passes through the optical delay phase detection structure to generate an error signal associated with a frequency of the millimeter-wave signal. The error signal is controlled by the feedback control loop to change temperature and driving current of the slave laser, and adjust a difference between output wavelengths of the master laser and the slave laser, and at last maintain the frequency and phase of the millimeter-wave be stable.

### FIELD OF THE DISCLOSURE

The disclosure belongs to the field of optoelectronic technology, and in particular relates to a device for generating wide capture range frequency tunable optical millimeter-wave signal.

### BACKGROUND OF THE DISCLOSURE

With the continuous development of the modern economy and the continuous innovation of communication equipment, the frequency range that can be used by the fundamental frequency is becoming less and less. Increase in the frequency of the communication frequency band has become an inevitable trend. Millimeter wave provides a wider communication bandwidth (about 60 GHz) for optical communication. Moreover, with its unique advantages, millimeter wave has broad application prospects in ROF links, phased arrays, 5G, and radar systems. At the same time, with the continuous development and improvement of microwave photonics, the scope of application has become wider and wider. This is why the optical millimeter wave came into being. It overcomes the difficulty of generating millimeter-wave signals in the electrical domain and can generate very high-frequency and high-quality millimeter-wave signals. Thanks to this, the research on millimeter-wave signals can be carried out smoothly.

Optical millimeter wave is one of the most core parts in the future optical communication system, and how to generate high-frequency, high-quality optical millimeter wave is the top priority. Among them, the most important methods are as follows: electro-optic modulation method, optical heterodyne method, harmonic frequency generation method and some other new technologies. The main structure of the electro-optic modulation method is to modulate the radio frequency signal (intensity/phase modulation) onto the optical carrier, use the nonlinearity of the modulator to generate upper and lower sidebands, and then filter by a specific optical filter and photodetector (PD) beat frequency; after that, the optical millimeter-wave signal with several frequency multiples can be obtained. However, this method requires high-quality RF signals as support, and the process of the electro-optic modulator itself also limits the spectral purity of millimeter-wave signals. The harmonic frequency generation method refers to the use of the high nonlinear phenomenon of optical devices, such as the high-order harmonic components generated by the four-wave mixing (FWM) phenomenon of the high nonlinear fiber (HNLF), and then select two of them through an optical filter. The spectrum line is beat frequency, so as to obtain the corresponding millimeter-wave signal. The difficulty of this scheme lies in the generation and extraction of harmonics, and the requirements for the device are relatively high. The optical heterodyne method refers to the use of optical signals emitted by two lasers with fixed frequencies to obtain a millimeter-wave signal whose frequency is the frequency difference between the two beams of light through the PD beat frequency. In theory, the millimeter-wave frequency generated by the optical heterodyne method can be very high and is only limited by the bandwidth of the PD, so the generation of millimeter-wave signals in the Ka-band and above has significant advantages. However, since the system structure uses two laser light sources, the incoherence between them will cause the phase noise of the millimeter-wave signal from the beat frequency to be relatively large. Therefore, it is of importance for microwave photonics filed to improve the frequency stability and phase noise characteristics of the millimeter-wave signal.

In the field of microwave photonics, the delay measurement of signal is an important measurement and information processing means. In the traditional microwave field, researchers often use devices such as coaxial cables to realize the delay of radio frequency signals, but the signals transmittable by the coaxial cables are narrow signal bandwidth, and there is often a large loss. These shortcomings have always plagued researchers. With the rapid development of microwave photonics, optical delay technology has been proposed. It modulates the microwave signal onto the optical carrier through electro-optic, and uses a certain method to delay the optical signal in the transmission process. The advantages of strong interference and low loss have become the main way of optical signal transmission. In the field of early optical communication, optical fibers with adjustable length were also used to realize the delay of optical signals, but the accuracy was not high.

### SUMMARY OF THE DISCLOSURE

With the development of optical delay technology, an optical fiber delay structure based on the change of optical fiber optical path proposed. The position of the internal mirror is adjusted by a stepper motor, so as to change the spatial optical path of light propagation and achieve the purpose of adjusting the delay. This method has high precision, generally can reach the femtosecond level and has a large delay adjustment range. The realization of the optical path delay phase detection structure also benefits from the development of optical delay technology. Due to the phase detector structure composed of the mixer and the low-pass filter, if and only when the input two signals have the same frequency and are orthogonal, the output error signal is 0. Using this, the phase difference of the two RF signals can be locked at 90°, that is, the adjustable optical delay line can be used to realize the function of wide-range tuning of the millimeter-wave signal, and compared with the traditional optical heterodyne. The structure has greatly improved the locking range, phase noise characteristics, frequency stability, and tunability of millimeter-wave signals.

A device for generating wide capture range tunable optical millimeter-wave signal is provided. The device includes a millimeter-wave signal generating structure, a millimeter-wave signal modulation structure, an optical path delay phase detection structure and a feedback control loop. The millimeter-wave signal generating structure obtains a millimeter-wave signal through the beat frequency of the optical signals generated by a master laser and a slave laser; the millimeter-wave signal is modulated to the optical carrier of the master laser through an electro-optical modulation structure, and then generates an error signal related to the frequency of the millimeter-wave signal. The error signal is controlled by the feedback control loop, which adaptively changes the temperature and driving current of the slave laser, and cooperatively adjusts the difference between the output wavelengths of the master laser and the slave laser, and finally maintains the stability of the frequency and phase of the millimeter-wave signal. Changing the adjustable optical fiber delay line in the optical delay phase detection structure can realize wide-range capture and tuning of millimeter-wave signal frequencies.

The millimeter-wave signal generation structure includes the master laser, the slave laser, a first 1×2 optical coupler, a 2×2 optical coupler, and a millimeter-wave signal generation structure high-speed photodetector.

The first laser (master laser) and second laser (slave laser) produce two optical signals L1 and L2 with specific wavelength, respectively, for guaranteeing the quality of the produced millimeter-wave signals. The master laser generally selects narrow linewidth laser for use, The optical signal L1 is input into the first 1×2 optical coupler, and the optical signal L2 is input into the 2×2 optical coupler. The first 1×2 optical coupler is used to divide the optical signal L1 output by the master laser into two paths of optical signals, i.e., the optical signal L11 and the optical signal L12. The optical signal L11 enters the 2×2 optical coupler, and the optical signal L12 is input into the millimeter-wave signal modulation structure. The 2×2 optical coupler is used to couple the optical signal L11 and the optical signal L2, and input the coupled optical signals to the millimeter-wave signal generation structure high-speed photodetector. The millimeter-wave signal generation structured high-speed photodetector is used to beat the coupled optical signals to generate a millimeter-wave signal whose frequency is f_{RF}, and input the millimeter-wave signal to the millimeter-wave signal modulation structure.

The millimeter-wave signal modulation structure includes a Mach Zehnder electro-optical modulator (MZM) and an electrical power divider.

The electric power divider divides the millimeter-wave signal into two paths, i.e., E1 and E2. E1 carries out the output of signal, E2 is input to the radio frequency input end of the MZM to regulate the DC bias voltage of the MZM, and make it work at orthogonal point, which is used to modulate the optical signal onto the radio frequency signal E2, thereby outputting an optical signal L3 to the optical path delay phase detection structure.

The optical path delay phase detection structure includes a second 1×2 optical coupler, an adjustable optical fiber delay line, a first optical path delay phase detection structure, a second optical path delay phase detection structure high-speed photodetector, a mixer, and a low-pass filter.

The second 1×2 optical coupler is used to divide the optical signal L3 into two paths, i.e., the optical signal L31 and the optical signal L32. The adjustable optical fiber delay line is used to equalize the delays of the two paths of signals and generate a delay τ at the same time, so that the corresponding phase difference 2πf_{RF}τ is generated between the two signals, and the optical signal L31′ is output. The first optical path delay phase detection structure high-speed photodetector is used to convert the optical signal L31′ into an electrical signal E3. The second optical path delay phase detection structure high-speed photodetector is used to convert the optical signal L32 into an electrical signal E4. The mixer is used to mix the radio frequency signal E3 and the radio frequency signal E4 to obtain a phase-difference signal. The low-pass filter is used to perform low-pass filtering on the phase-difference signal, filter out high-frequency components, and obtain a DC error signal and input to the feedback control loop.

For the phase detection structure composed of the mixer and the low-pass filter, only when the input signals are of the same frequency and quadrature, the output error signal is 0, that is, the lock point. Ideally, there can be infinite locking points, but due to the limitation of the actual device bandwidth, the phase is generally locked at

$$\frac{π}{2} ,$$

so the final locked frequency of the millimeter-wave signal

$${f}_{RF\_Locked} = \frac{1}{4 τ} .$$

Accordingly, when adjusting the delay r of the fiber delay line, a wide range of millimeter-wave signal frequencies can be tuned. At the same time, the capture range can
be obtained as

$${f}_{RF\_Locked} - \frac{1}{4 τ} to {f}_{RF\_Locked} + \frac{1}{4 τ} .$$

That is, the frequency f_{RF} of the millimeter-wave signal generated by the optical heterodyne beat frequency falls from 0 to

$$\frac{1}{2 τ}$$

can be captured by the system, and finally stabilized to

$${f}_{RF\_Locked} = \frac{1}{4 τ} .$$

The feedback control loop includes a controllable pumping current source, a single-chip microcomputer control circuit.

The controllable current source is capable of, according to the error signal of input, adaptively changing the size of drive current from the laser, and then changing the output wavelength from the laser with high precision in narrow range. The output error signal is sampled and processed by the single-chip microcomputer control circuit. The operating temperature of the slave laser is adjusted according to the size of the error voltage, so as to change the output wavelength of the slave laser in a wide range and with low precision. The complementary characteristics of the temperature and the driving current to adjust the output wavelength of the laser are used to jointly complete the tuning and stabilization. frequency effect.

### BRIEF DESCRIPTION OF DRAWINGS

FIG. 1 is a schematic diagram of the device for generating wide capture range frequency tunable optical millimeter-wave signal according to the present disclosure.

In the drawings: 1-Master laser, 2-Slave laser, 3-First 1×2 optical coupler, 4-2×2 optical coupler, 5-Millimeter-wave signal generation structure high-speed photodetector, 6-Electrical power divider, 7-electro-optic modulator, 8-second 1×2 optical coupler, 9-adjustable fiber delay line, 10-first optical path delay phase detection structure high-speed photodetector, 11-second optical path delay phase detection structure high-speed photodetector, 12-mixer, 13-low-pass filter, 14-controllable current source, 15-single-chip microcomputer control circuit.

FIG. 2 is the schematic diagram of the relationship between the low-pass filter output error signal normalized amplitude and the millimeter-wave signal frequency of the device according to the present disclosure under ideal conditions.

### DETAILED DESCRIPTION OF THE DISCLOSURE

In order to describe the present disclosure more specifically, the technical solutions of the present disclosure will be described in detail below with reference to the accompanying drawings and specific embodiments.

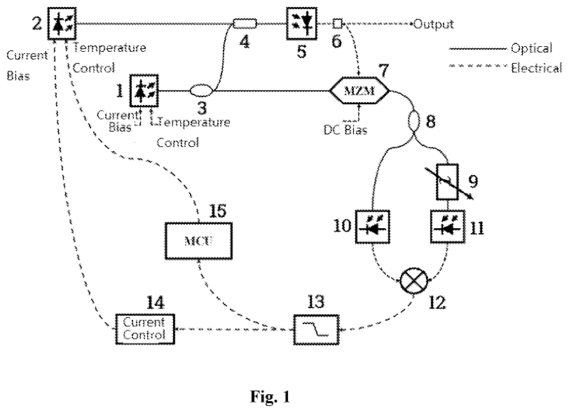

The present disclosure is based on a device for generating wide capture range tunable optical millimeter-wave signal based on an optical phase-locked loop. The entire system includes a millimeter-wave signal generating structure, a millimeter-wave signal modulation structure, an optical path delay phase detection structure and a feedback control loop. As shown in FIG. 1, the millimeter-wave signal generating structure includes a master laser 1, a slave laser 2, a first 1×2 optical coupler 3, a 2×2 optical coupler 4, and a millimeter-wave signal generating structure high-speed photodetector 5. The millimeter-wave signal modulation structure includes the main laser 1, the first 1×2 optical coupler 3, an electrical power divider 6, and an electro-optical modulator 7. The optical path delay phase detection structure includes a second 1×2 optical coupler 8, an adjustable fiber delay line 9, a first optical path delay phase detection structure high-speed photodetector 10, a second optical path delay phase detection structure high-speed photodetector 11, a mixer 12, and a low-pass filter 13. The feedback control loop includes the current source 14 and the single-chip control microcomputer control circuit 15. The millimeter-wave signal finally generated by the system is outputted by one of paths of the electric power dividers 6.

The light L1 that the main laser 1 outputs is coupled into the first 1×2 optical coupler 3 through a polarization-maintaining fiber, and is branched into L11 and L12 through the first 1×2 optical coupler 3. The L11 and the polarization-maintaining fiber carrying light L2 output by the slave laser are coupled into the 2×2 optical coupler 4. The output light of the 2×2 optical coupler 4 is connected to and beat by the millimeter-wave signal generating structure high-speed photodetector 5 through the optical fiber to obtain a millimeter-wave signal. After divided by the electrical power divider 6, E1 is being the signal output end, which can be connected to the spectrum analyzer for observation, or can be connected to the millimeter-wave input port of other specific systems; E2 is coupled to the RF input port of the electro-optic modulator 7 through a radio frequency line. The other optical path L12 output by the first 1×2 optical coupler 2 is coupled into the optical input port of the electro-optical modulator 7 to form a millimeter-wave signal modulation structure. The millimeter-wave signal is modulated to the optical carrier and connected to the second 1×2 optical coupler 8 through the optical fiber L3 via the output port of the electro-optic modulator 7. The output of the 1×2 optical coupler 8 is connected to the adjustable optical fiber delay line 9 and the first optical path delay phase detection structure high-speed photodetector 10, respectively, through the optical fibers L31, L32. The adjustable optical fiber delay line 9 outputs the optical signal after delay time τ, and is connected to the second optical path delay phase detection structure high-speed photodetector 11 through the optical fiber L31′. The optical signals on the optical paths L31′ and L32 respectively beat by the first optical delay phase detection structure high-speed photodetector 10 and the second optical delay phase detection structure high-speed photodetector 11 the output RF signals are connected to the two RF input ports of the mixer 12 through the RF lines E3 and E4. The output of the mixer 12 is connected to the low-pass filter 13. This forms the optical path delay phase detection structure. The low-pass filter 13 outputs an error signal, and inputs the error signal to the controllable current source 14 to control the drive current of the slave laser 2. At the same time, the single-chip microcomputer also samples the output error signal, and feedback to control the temperature of the lasers. These two together complete the tuning of the wavelength of the slave laser 2, forming the feedback control loop.

In the present embodiment, the master laser selects the laser of narrow linewidth. The drive current and temperature keep constant, and only the drive current and temperature of the slave laser is adjusted, thereby realizes the frequency tuning and high stability of millimeter-wave signal. The temperature has a large change range for the frequency of the millimeter-wave signal, which can be used for rough adjustment. The adjustment range of the driving current to the frequency of the millimeter-wave signal is small but fast and approximately linear, so it can be used for fine adjustment. Accordingly, in this solution, when using the adjustable fiber delay line to tune the millimeter-wave signal, the temperature can be used for coarse adjustment first, and after the error signal voltage is less than a certain threshold, the control current is finely adjusted, which can ensure that the millimeter-wave signal is tuned in a wide range, and at the same time ensure the stability of the frequency of the millimeter-wave signal.

In the present embodiment, optical path delay phase detection structure includes a high-precision adjustable optical fiber delay line, the first optical path delay phase detection structure high-speed photodetector, the second optical path delay phase detection structure high-speed photodetector, a mixer and a low-pass filter. The low-pass filter outputs the error signal for subsequent circuit processing. The first optical path delay phase detection structure high-speed photodetector and the second optical path delay phase detection structure high-speed photodetector are identical in performance.

In the present embodiment, the effect of the high-precision adjustable optical fiber delay line is: one is to produces a certain time delay (denoted as τ), when the optical signal modulated with radio frequency passes through the delay τ, the phase can occur 2πf_{RF}τ change, and then output the DC error signal after the phase detector composed of the mixer and the low-pass filter. Due to the physical characteristics of this kind of phase detector, only when the input phase difference is

$$\frac{π}{2} + k π ,$$

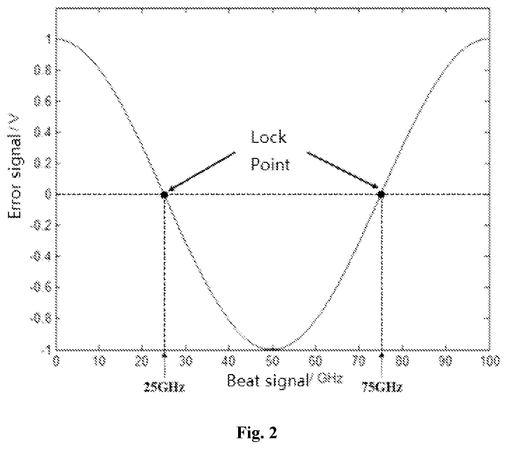

k=1,2,3 . . . , the output error signal is 0. Therefore, the curve of the voltage of the error signal and the frequency of the radio frequency signal can be obtained, as shown in FIG. 2. However, due to the physical limitations of the device, the phase of the locking point is generally set to

$$\frac{π}{2} .$$

At this time, the final locked frequency of the millimeter-wave signal is

$${f}_{RF\_Locked} = \frac{1}{4 τ} .$$

By adjusting the delay τ of the optical fiber delay line, the tuned output of the millimeter-wave signal can be realized. For example, when the adjustable fiber delay line delay τ=10 ps is set, corresponding to only the RF signal frequency f_{RF}=25 GHz generated by the above millimeter-wave signal generating structure, the error signal output by the low-pass filter will be 0, that is, the frequency is locked, as shown in FIG. 2. At the same time, the ideal capture range is 0-50 GHz, that is, when the millimeter-wave signal frequency f_{RF}≠25 GHz and falls within the capture range, the value of the output error signal can be determined according to the value of the output error signal, adjust the drive current and temperature of the slave laser, and finally stabilize the frequency of the millimeter-wave signal at 25 GHz. When the adjustable fiber delay line delay τ=12.5 ps, it can generate a millimeter wave with frequency f_{RF}=20 GHz signal, that is, the tuning of the millimeter-wave signal in the 5 GHz range is realized. The second is used to balance the delay of the reference circuit. In the actual system, in addition to the adjustable optical fiber delay line that can delay the two signals, the difference in the lengths of the two optical fibers and RF lines, and the photoelectric detector will cause the two channels to be delayed. The signal produces a delay deviation, so an adjustable optical fiber delay line is required to balance this delay, so as to ensure the accuracy of the millimeter-wave signal.

The above description of the embodiments is for the convenience of those of ordinary skill in the art to understand and apply the present disclosure. It will be apparent to those skilled in the art that various modifications to the above-described embodiments can be readily made, and the general principles described herein can be applied to other embodiments without inventive effort. Therefore, the present disclosure is not limited to the above-mentioned embodiments, and improvements and modifications made by those skilled in the art according to the disclosure of the present disclosure should all fall within the protection scope of the present disclosure.

What is claimed is:

1. A device for generating wide capture range frequency tunable optical millimeter-wave signal, comprising a millimeter-wave signal generating structure, a millimeter-wave signal modulation structure, an optical delay phase detection structure and a feedback control loop;
wherein the millimeter-wave signal generating structure obtains the millimeter-wave signal by a beat frequency of the optical signal generated by a master laser and a slave laser, the millimeter-wave signal is modulated onto an optical carrier of the master laser by the electro-optical modulation structure, and then passes through the optical delay phase detection structure to generate an error signal associated with a frequency of the millimeter-wave signal;
the error signal is controlled by the feedback control loop to adaptively change temperature and driving current of the slave laser, and coordinately adjust a difference between output wavelengths of the master laser and the slave laser, and at last maintain the frequency and phase of the millimeter-wave be stable; and by changing the length of the tunable optical fiber delay line in the optical delay phase detection structure, frequency tunability of wide capture range of the frequency of the millimeter-wave signal is realized.

2. The device according to claim 1, wherein the millimeter-wave signal generating structure comprises: the master laser, the slave laser, a first 1×2 optical coupler, and a 2×2 optical coupler, and a millimeter-wave signal generation structure high-speed photodetector;
the master laser and the slave laser each generates two optical signals L1 and L2 with specific wavelengths;
the main laser is a narrow linewidth laser;
the optical signal L1 is input to the first 1×2 optical coupler, and the optical signal L2 is input to the 2×2 optical coupler;
the first 1×2 optical coupler is configured to divide the optical signal L1 output by the master laser into two optical signals L11 and L12; wherein, the optical signal L11 enters the 2×2 optical coupler, and the optical signal L12 is input to the millimeter-wave signal modulation structure;
the 2×2 optical coupler is configured to couple the optical signal L11 and the optical signal L2 into the millimeter-wave signal generating structure high-speed photodetector;
the millimeter-wave signal generating structure high-speed photodetector is configured to perform beat frequency on the coupled optical signal, generate a millimeter-wave signal with a frequency f_{RF}, and the millimeter-wave signal is input to the millimeter-wave signal modulation structure.

3. The device according to claim 2, wherein the millimeter-wave signal modulation structure comprises a Mach Zehnder electro-optical modulator (MZM) and an electrical power divider;
the electrical power divider divides the millimeter-wave signal into two paths: a radio frequency signal E1 and a radio frequency signal E2; the radio frequency signal E1 is configured for signal output, and the radio frequency signal E2 is input to a radio frequency input end of the MZM for adjusting a DC bias voltage of the MZM and make the DC bias voltage work at a quadrature point, so that the optical signal is modulated to the radio frequency signal E2, and optical signal L3 is output to the optical delay phase detection structure.

4. The device according to claim 3, wherein the optical delay phase detection structure comprises a second 1×2 optical coupler, an adjustable optical fiber delay line, and a first optical delay phase detection structure high-speed photodetector, a second optical delay phase detection structure high-speed photodetector, a mixer, and a low-pass filter;
the second 1×2 optical coupler is configured to divide the optical signal L3 into an optical signal L31 and an optical signal L32;
the adjustable optical fiber delay line is configured to equalize the delays of the optical signal L31 and an optical signal L32 and generate a delay τ, so that the optical signal L31 and an optical signal L32 generate a corresponding phase difference 2πf_{RF}τ, and output an optical signal L31′;
the first optical delay phase detection structure high-speed photodetector is configured to convert the optical signal L31′ into a radio frequency signal E3;
the second optical delay phase detection structure high-speed photodetector is configured to convert the optical signal L32 into the radio frequency signal E4;
the mixer is configured to mix the radio frequency signal E3 and the radio frequency signal E4 to obtain a phase difference signal;
the low-pass filter is configured to perform low-pass filtering on the phase difference signal, filter out high-frequency components, and obtain a DC error signal and input the DC error signal into the feedback control loop;
for the phase detector structure composed of a mixer and a low-pass filter, only when the input signals are of the same frequency and quadrature, the output error signal is 0, that is, the locking point; ideally, there can be infinitely many locking points, however, due to the limitation of the actual device bandwidth, the phase is locked at
$$\frac{π}{2} ,$$
so the final locking frequency of the millimeter-wave signal
$${f}_{RF\_Locked} = \frac{1}{4 τ}$$
can be obtained; therefore, when adjusting the delay τ of the optical fiber delay line, a wide range of millimeter-wave signal frequencies can be tuned; at the same time, the capture range can be obtained from
$${f}_{RF\_Locked} - \frac{1}{4 τ} to {f}_{RF\_Locked} + \frac{1}{4 τ} ,$$
that is, theoretically, the frequency f_{RF} of the millimeter-wave signal generated by the system can be captured by the system if it falls within the capture range of 0 to
$$\frac{1}{2 τ} ;$$
from the co-tuning of laser temperature and drive current, the signal frequency is finally stabilized to
$${f}_{RF\_Locked} = \frac{1}{4 τ} .$$

5. The device according to claim 4, wherein the feedback control loop comprises a controllable current source and a single-chip microcomputer control circuit;
the controllable current source is capable of, according to the input error signal, adaptively changing the size of the driving current input to the slave laser, and then changing the output wavelength of the slave laser with high precision in a narrow range, keeping the frequency of the millimeter-wave signal locked;
the single-chip microcomputer control circuit the output error signal is sampled and processed by the single-chip microcomputer, and the operating temperature of the slave laser is adjusted accordingly according to the error voltage, so as to change the output wavelength of the slave laser in a wide range and with low precision, and realize the wide-range tuning of the milliner-wave signal.
